(19) United States
(12) Patent Application Publication
(10) Pub. No.: US 2014/0070148 A1
(43) Pub. Date: Mar. 13, 2014

(54) CONDUCTIVE POWDER, ARTICLE, AND CONDUCTIVE PASTE

(71) Applicant: Samsung Electronics Co., Ltd., Suwon-Si (JP)

(72) Inventors: Suk Jun KIM, Suwon-si (KR); Keum Hwan PARK, Seoul (KR); Eun Sung LEE, Hwaseong-si (KR); Se Yun KIM, Seoul (KR); Jin Man PARK, Seoul (KR); Sang Soo JEE, Hwaseong-si (KR)

(73) Assignee: SAMSUNG ELECTRONICS CO., LTD., Suwon-Si (KR)

(21) Appl. No.: 14/024,107

(22) Filed: Sep. 11, 2013

(30) Foreign Application Priority Data
Sep. 12, 2012 (KR) 10-2012-0101001

(51) Int. Cl. H01B 1/02

(52) U.S. Cl. CPC H01B 1/02
USPC 252/514

(57) ABSTRACT

According to example embodiments, a conductive powder includes a metallic glass and a coating on the surface of the metallic glass. The coating includes a metal. An article may include a sintered product of the conductive powder. A conductive paste may include the conductive powder. An electronic device may include a sintered product of the conductive paste.

This application claims priority under 35 U.S.C. §119 to Korean Patent Application No. 10-2012-0101001 filed in the Korean Intellectual Property Office on Sep. 12, 2012, the entire contents of which are incorporated herein by reference.

### BACKGROUND

1. Field

Example embodiments relate to a conductive powder, an article, and/or a conductive paste.

2. Description of Related Art

An electrode for an electronic device may be formed by applying a conductive paste to an article and sintering the conductive paste. Some conductive pastes may include metal particles and glass frit. However, the glass frit has high specific resistance and thus may reduce the conductivity of an electrode formed from a conductive paste that includes a glass frit. Recently, a conductive paste including a metallic glass instead of glass frit has improved conductivity. However, the metallic glass may be at least partially crystallized and oxidized during a process, and thus, conductivity of the metallic glass may be deteriorated.

### SUMMARY

Example embodiments relate to a conductive powder that improves oxidation resistance and conductivity and lowers manufacturing cost.

Example embodiments also relate to an article including a sintered product of the conductive powder.

Example embodiments also relate to a conductive paste including the conductive powder.

According to example embodiments, a conductive powder includes a metallic glass and a coating on a surface of the metallic glass. The coating includes a metal.

In example embodiments, an oxidation resistance of the metal may be higher than an oxidation resistance of the metallic glass.

In example embodiments, the metal may include one of silver (Ag), gold (Au), palladium (Pd), platinum (Pt), ruthenium (Ru), rhodium (Rh), osmium (Os), iridium (Ir), rhenium (Re), titanium (Ti), niobium (Nb), tantalum (Ta), aluminum (Al), copper (Cu), nickel (Ni), molybdenum (Mo), vanadium (V), zinc (Zn), magnesium (Mg), yttrium (Y), cobalt (Co), zirconium (Zr), iron (Fe), tungsten (W), tin (Sn), chromium (Cr), manganese (Mn), and a combination thereof.

In example embodiments, the metallic glass may be an alloy including at least one of copper (Cu), titanium (Ti), nickel (Ni), zirconium (Zr), iron (Fe), magnesium (Mg), calcium (Ca), cobalt (Co), palladium (Pd), platinum (Pt), gold (Au), cerium (Ce), lanthanum (La), yttrium (Y), gadolinium (Gd), beryllium (Be), tantalum (Ta), gallium (Ga), aluminum (Al), hafnium (Hf), niobium (Nb), lead (Pb), platinum (Pt), silver (Ag), phosphorus (P), boron (B), silicon (Si), carbon (C), tin (Sn), zinc (Zn), molybdenum (Mo), tungsten (W), manganese (Mn), erbium (Er), chromium (Cr), praseodymium (Pr), thulium (Tm), and a combination thereof.

In example embodiments, the metallic glass may be in the form of particles, and a thickness of the coating may be less than or equal to about 20% of a particle diameter of the metallic glass.

In example embodiments, a thickness of the coating may be about 1 nm to about 3 μm.

According to example embodiments, an article may include a sintered product of the conductive powder.

In example embodiments, the sintered product of the conductive powder may include a crystallized product of the metallic glass and a sintered metal surrounding the crystallized product of the metallic glass.

According to example embodiments, a conductive paste includes a conductive powder and an organic vehicle. The conductive powder includes a metallic glass and a coating on a surface of the metallic glass. The coating includes a metal.

In example embodiments, an oxidation resistance of the metal may be higher than an oxidation resistance of the metallic glass.

In example embodiments, the metal may include one of silver (Ag), gold (Au), palladium (Pd), platinum (Pt), ruthenium (Ru), rhodium (Rh), osmium (Os), iridium (Ir), rhenium (Re), titanium (Ti), niobium (Nb), tantalum (Ta), aluminum (Al), copper (Cu), nickel (Ni), molybdenum (Mo), vanadium (V), zinc (Zn), magnesium (Mg), yttrium (Y), cobalt (Co), zirconium (Zr), iron (Fe), tungsten (W), tin (Sn), chromium (Cr), manganese (Mn), and a combination thereof.

In example embodiments, the metallic glass may be an alloy including at least one of copper (Cu), titanium (Ti), nickel (Ni), zirconium (Zr), iron (Fe), magnesium (Mg), calcium (Ca), cobalt (Co), palladium (Pd), platinum (Pt), gold (Au), cerium (Ce), lanthanum (La), yttrium (Y), gadolinium (Gd), beryllium (Be), tantalum (Ta), gallium (Ga), aluminum (Al), hafnium (Hf), niobium (Nb), lead (Pb), platinum (Pt), silver (Ag), phosphorus (P), boron (B), silicon (Si), carbon (C), tin (Sn), zinc (Zn), molybdenum (Mo), tungsten (W), manganese (Mn), erbium (Er), chromium (Cr), praseodymium (Pr), thulium (Tm), and a combination thereof.

In example embodiments, the metallic glass may be in the form of particles, and a thickness of the coating may be less than or equal to about 20% of a particle diameter of the metallic glass.

In example embodiments, a thickness of the coating may be about 1 nm to about 3 μm.

In example embodiments, the conductive paste may further include metal particles.

In example embodiments, the metal particles may include one of silver (Ag), aluminum (Al), copper (Cu), nickel (Ni), and a combination thereof.

According to example embodiments, an electronic device may include an electrode including a sintered product of the conductive paste.

In example embodiments, the sintered product of the conductive paste may include a crystallized product of the metallic glass and a sintered metal surrounding the crystallized product of the metallic glass.

### BRIEF DESCRIPTION OF THE DRAWINGS

The foregoing and other features and advantages of example embodiments will be apparent from the more particular description of non-limiting embodiments of inventive concepts, as illustrated in the accompanying drawings in which like reference characters refer to the same parts throughout the different views. The drawings are not necessarily to scale, emphasis instead being placed upon illustrating principles of example embodiments. In the drawings:

FIG. 1 is a schematic view of a conductive powder according to example embodiments,

FIG. 2 is a schematic view showing a sintered product of a conductive powder according to example embodiments,

FIG. 3 is an scanning electron microscope (SEM) photograph of the conductive powder obtained in Example 1, and

FIG. 4 is a scanning electron microscope (SEM) photograph of the conductive powder obtained in Comparative Example 1.

### DETAILED DESCRIPTION

Example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, “element” may include a metal and a semi-metal.

A conductive powder according to example embodiments will now be described.

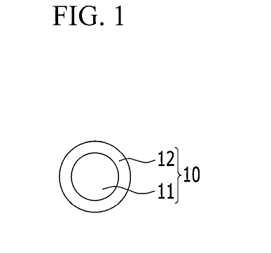

FIG. 1 is a schematic view of a conductive powder according to example embodiments.

A conductive powder 10 according to example embodiments includes a metallic glass 11 and a coating part 12 positioned on the surface of the metallic glass 11 and including a metal.

The metallic glass 11 is an amorphous alloy of two or more kinds of metals and/or semi-metals, and may be called an amorphous metal. The metallic glass 11 includes an amorphous part that is formed by quenching two or more kinds of metals and/or semi-metals. Herein, the amorphous part may be about 50 to about 100 volume %, specifically about 70 to about 100 volume %, and more specifically about 90 to 100 volume % of the total volume of the metallic glass 11.

The metallic glass 11 may maintain an amorphous part formed when having been a liquid phase at a high temperature, even at room temperature. Accordingly, the metallic glass 11 has a different structure from the crystalline structure of a general alloy having a regular arrangement of elements when the metallic glass is solidified into a solid phase, and also from a liquid metal structure at room temperature.

The metallic glass 11 has low resistivity and thus low conductivity, unlike a glass such as a silicate.

The metallic glass 11 may include, for example copper (Cu), titanium (Ti), nickel (Ni), zirconium (Zr), iron (Fe), magnesium (Mg), calcium (Ca), cobalt (Co), palladium (Pd), platinum (Pt), gold (Au), cerium (Ce), lanthanum (La), yttrium (Y), gadolinium (Gd), beryllium (Be), tantalum (Ta), gallium (Ga), aluminum (Al), hafnium (Hf), niobium (Nb), lead (Pb), platinum (Pt), silver (Ag), phosphorus (P), boron (B), silicon (Si), carbon (C), tin (Sn), zinc (Zn), molybdenum (Mo), tungsten (W), manganese (Mn), erbium (Er), chromium (Cr), praseodymium (Pr), thulium (Tm), and a combination thereof, without limitation.

The metallic glass may include, for example an aluminum-based metallic glass, a copper-based metallic glass, a titanium-based metallic glass, a nickel-based metallic glass, a zirconium-based metallic glass, an iron-based metallic glass, a cerium-based metallic glass, a strontium-based metallic glass, a gold-based metallic glass, a ytterbium-based metallic glass, a zinc-based metallic glass, a calcium-based metallic glass, a magnesium-based metallic glass, a platinum-based metallic glass, and the like, but is not limited thereto.

The aluminum-based metallic glass, copper-based metallic glass, titanium-based metallic glass, nickel-based metallic glass, zirconium-based metallic glass, iron-based metallic glass, cerium-based metallic glass, strontium-based metallic glass, gold-based metallic glass, ytterbium-based metallic glass, zinc-based metallic glass, calcium-based metallic glass, magnesium-based metallic glass, and platinum-based metallic glass may be an alloy including aluminum, copper, titanium, nickel, zirconium, iron, cerium, strontium, gold, ytterbium, zinc, calcium, magnesium, and platinum as a main component, respectively, and may further include at least one selected from nickel (Ni), yttrium (Y), cobalt (Co), lanthanum (La), zirconium (Zr), iron (Fe), titanium (Ti), calcium (Ca), beryllium (Be), magnesium (Mg), sodium (Na), molybdenum (Mo), tungsten (W), tin (Sn), zinc (Zn), potassium (K), lithium (Li), phosphorus (P), palladium (Pd), platinum (Pt), rubidium (Rb), chromium (Cr), strontium (Sr), cerium (Ce), praseodymium (Pr), promethium (Pm), samarium (Sm), lutetium (Lu), neodymium (Nd), niobium (Nb), gadolinium (Gd), terbium (Tb), dysprosium (Dy), holmium (Ho), erbium (Er), thulium (Tm), thulium (Th), scandium (Sc), barium (Ba), ytterbium (Yb), europium (Eu), hafnium (Hf), arsenic (As), plutonium (Pu), gallium (Ga), germanium (Ge), antimony (Sb), silicon (Si), cadmium (Cd), indium (In), platinum (Pt), manganese (Mn), niobium (Nb), osmium (Os), vanadium (V), aluminum (Al), copper (Cu), silver (Ag), and mercury (Hg). Herein, the main component has the highest mole ratio among the components of the metallic glass.

The coating part 12 is positioned on the surface of the metallic glass 11. In the drawing, the coating part 12 surrounds the metallic glass 11, but example embodiments are not limited thereto, and may be positioned on at least one part of the surface of the metallic glass 11. For example, the coating part 12 may exist as islands on a part of the surface of the metallic glass 11 or as a layer covering the whole surface of the metallic glass 11.

The coating part 12 includes a metal. The metal may have higher oxidation resistance than that of the metallic glass 11 and may limit and/or prevent oxidation of the metallic glass 11 during heat treatment.

When the coating part 12 is not formed, the metallic glass 11 may be crystallized at greater than or equal to a crystallization temperature (Tx) thereof during heat treatment, and thus may have a plurality of grain boundaries through which oxygen flows through the grain boundaries to cause oxidation. This oxidized metallic glass may have sharply deteriorated conductivity. The coating part 12 may limit and/or prevent oxidation of the metallic glass 11 on the surface and thus may limit and/or prevent a conductivity deterioration of the conductive powder 10.

In addition, the metal in general may have a lower specific resistance than that of the metallic glass 11 and thus may improve conductivity of the conductive powder 10.

The metal may be selected from metals having oxidation stability but high specific resistance in the air and/or under a vacuum atmosphere, for example, from silver (Ag), gold (Au), palladium (Pd), platinum (Pt), ruthenium (Ru), rhodium (Rh), osmium (Os), iridium (Ir), rhenium (Re), titanium (Ti), niobium (Nb), tantalum (Ta), aluminum (Al), copper (Cu), nickel (Ni), molybdenum (Mo), vanadium (V), zinc (Zn), magnesium (Mg), yttrium (Y), cobalt (Co), zirconium (Zr), iron (Fe), tungsten (W), tin (Sn), chromium (Cr), manganese (Mn), or a combination thereof.

The coating part 12 may have a thickness of less than or equal to about 20% relative to a particle diameter of the metallic glass 11. For example, the coating part 12 may have a thickness of about 1 nm to about 3 μm, and specifically, a thickness ranging from about 10 nm to about 1 μm within the above-described range. When the coating part 12 has a thickness within the range, the oxidation resistance and conductivity may not only improve but the coating property of the coating part 12 may also be secured.

The conductive powder 10 may be applied to manufacture an article.

The article may be a sintered product obtained by heat-treating the conductive powder 10 at greater than or equal to a sintering temperature.

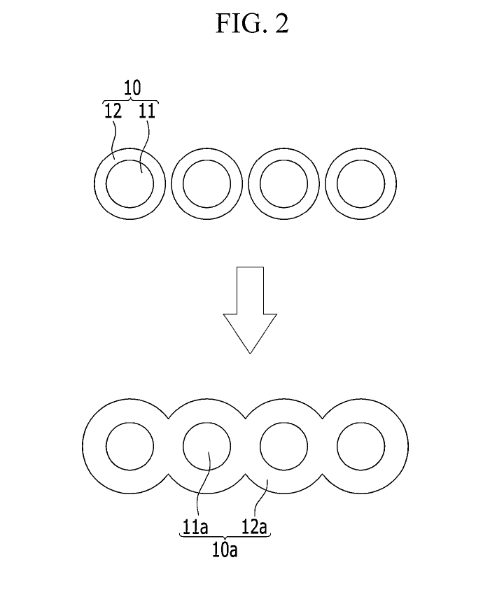

FIG. 2 is a schematic view showing a sintered product of the conductive powder 10.

Referring to FIG. 2, when the conductive powder 10 including the metallic glass 11 and the coating part 12 is heat-treated at greater than or equal to the sintering temperature of the conductive powder 10 in the air or under vacuum, the metallic glass 11 may be crystallized, while a metal in the coating part 12 may be sintered. Accordingly, a sintered product 10a of the conductive powder may include a crystallized metallic glass 11a and a sintered metal 12a surrounding the crystallized metallic glass 11a.

The article may be variously applied to, for example, a mobile phone case, a golf head, a clock, and the like.

The metallic glass may be applicable to a conductive paste.

The conductive paste may include a conductive powder according to example embodiments and an organic vehicle.

The conductive powder may be the same as described above.

The organic vehicle may include an organic compound mixed with the conductive powder that imparts viscosity to the organic vehicle, and a solvent dissolving the above components.

The organic compound may include, for example, at least one selected from a (meth)acrylate-based resin, a cellulose resin such as ethyl cellulose, a phenol resin, an alcohol resin, TEFLON (tetrafluoroethylene), and a combination thereof, and may further include an additive such as a dispersing agent, a surfactant, a thickener, and a stabilizer.

The solvent may be any solvent being capable of dissolving the above compounds, and may include, for example, at least one selected from terpineol, butyl carbitol, butyl carbitol acetate, pentanediol, dipentyne, limonene, ethylene glycol alkylether, diethylene glycol alkylether, ethylene glycol alkylether acetate, diethylene glycol alkylether acetate, diethylene glycol dialkylether acetate, triethylene glycol alkylether acetate, triethylene glycol alkylether, propylene glycol alkylether, propylene glycol phenylether, dipropylene glycol alkylether, tripropylene glycol alkylether, propylene glycol alkylether acetate, dipropylene glycol alkylether acetate, tripropylene glycol alkyl ether acetate, dimethylphthalic acid, diethylphthalic acid, dibutyl phthalic acid, and desalted water.

The conductive paste may further include metal particles.

The metal particles may include a silver (Ag)-containing metal such as silver or a silver alloy, an aluminum (Al)-containing metal such as aluminum or an aluminum alloy, a copper (Cu)-containing metal such as copper (Cu) or a copper alloy, a nickel (Ni)-containing metal such as nickel (Ni) or a nickel alloy, or a combination thereof. However, the metal particles are not limited thereto, and may include other metals and an additive other than the metals.

The conductive powder may have a size (e.g., average largest particle size) ranging from about 1 nm to about 50 μm, and may include one or more kinds of metal.

The conductive powder and the metal particles may apply conductivity to a conductive paste. Since the conductive powder may be advantageous in terms of a price compared with the metal particles, the conductive powder may be used singularly or mixed with the metal particles in an appropriate ratio depending on a purpose. When the conductive powder and the metal particles are used together, the conductive powder and the metal particles are respectively included in an amount of about 1 to about 99 volume %.

The total amounts of the conductive powder, and the metal particles and the organic vehicle, are respectively included in an amount of about 30 wt % to about 99 wt % and in a balance amount based on the total amount of the conductive paste.

The conductive paste may be applied by screen-printing to provide an electrode for an electronic device. The electronic device may include, for example, a liquid crystal display (LCD), a plasma display device (PDP), an organic light emitting diode (OLED) display, a solar cell, and the like.

The electrode may be made of a sintered product of a conductive paste according to example embodiments, and the sintered product of the conductive paste may include the crystallized metallic glass and the sintered metal surrounding the crystallized metallic glass.

Hereinafter, the following examples are described in more detail. However, it is understood that this disclosure is not limited by these examples.

### Preparation of Conductive Powder

### Example 1

0.25 g of metallic glass Al₈₅Ni₅Y₈Co₂ is dispersed in 25 ml of ethanol, and then a solution is prepared by adding 0.85 g of AgNO₃ and 4 ml of NH₄OH to 25 ml of water is added thereto. While the mixed solution is agitated at room temperature, 30 ml of acetaldehyde is added thereto, obtaining a conductive powder that includes a metallic glass coated with silver (Ag).

### Example 2

A conductive powder that includes metallic glass coated with gold (Au), is prepared according to the same method as Example 1, except for using HAuCl₄ instead of the AgNO₃.

### Example 3

A conductive powder that includes a metallic glass coated with palladium (Pd), is prepared according to the same method as Example, 1 except for using PdCl₂ instead of the AgNO₃.

### Comparative Example 1

A conductive powder, metallic glass Al₈₅Ni₅Y₈Co₂ coated with no metal, is prepared.

### Evaluation 1

### Examination of Conductive Powders

The conductive powders according to Example 1 and Comparative Example 1 were examined using a scanning electron microscope (SEM).

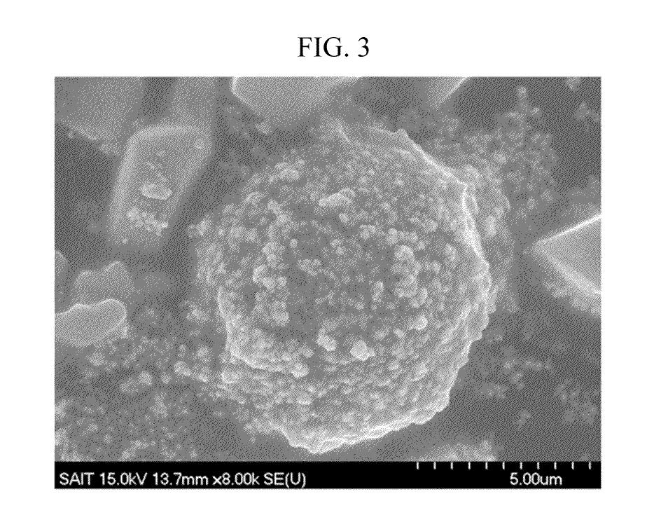

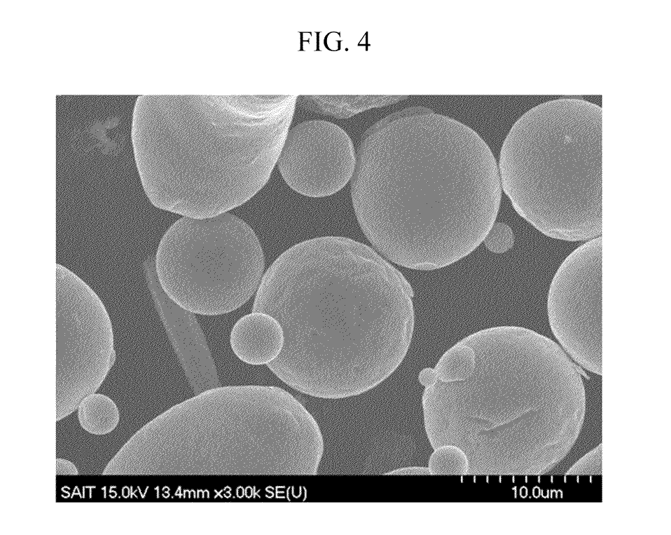

FIG. 3 is a scanning electron microscope (SEM) photograph showing the conductive powder obtained in Example 1, and FIG. 4 is a scanning electron microscope (SEM) photograph showing the conductive powder obtained in Comparative Example 1.

Comparing FIGS. 3 and 4, the conductive powder according to Example 1 turns out to be metallic glass coated with silver (Ag).

### Evaluation 2

### Oxidation Resistance

Oxidation resistance of the conductive powders according to Examples 1 to 3 and Comparative Example 1 is evaluated.

The oxidation resistance is evaluated by putting the conductive powders according to Examples 1 to 3 and Comparative Example 1 in a thermogravimetric analyzer and heating them to 600° C. at a speed of about 40° C./min, and then measuring their weight changes. The evaluation of the oxidation resistance is performed in air atmosphere at normal pressure.

The results are provided in Table 1.

TABLE 1

| | Weight increase per unit mass |
|---|---|
| | of conductive powder |
| | @ 600° C. (%) |
| Example 1 | 0.16 |
| Example 2 | 0.15 |
| Example 3 | 0.90 |
| Comparative Example 1 | 1.04 |

Referring to Table 1, the conductive powders according to Examples 1 to 3 show improved oxidation resistance compared with the conductive powder according to Comparative Example 1.

### Preparation of Conductive Paste and Electrode Samples

### Example 4

The conductive powder according to Example 1 and silver (Ag) particles are added to an organic vehicle including an ethyl cellulose binder, a surfactant, and a mixed solvent of butyl carbitol/butyl carbitol acetate. Herein, the silver (Ag) particles and the conductive powder according to Example 1 are included in a ratio of 90:10 (v/v). Subsequently, the mixture is kneaded with a 3-roll mill, preparing a conductive paste.

The conductive paste is coated on a silicon wafer in a screen printing method to form a pattern having a desired (and/or alternatively predetermined) length. Subsequently, the patterned silicon wafer is heated to about 600° C. by using a belt furnace and cooled, manufacturing an electrode sample having a desired (and/or alternatively predetermined) length. In other words, a process temperature setting of a furnace used to heat the patterned silicon wafer may be about 600° C.

### Example 5

An electrode sample is manufactured according to the same method as Example 4, except for using the conductive powder according to Example 2 instead of the conductive powder according to Example 1.

### Example 6

An electrode sample is manufactured according to the same method as Example 4, except for using the conductive powder according to Example 3 instead of the conductive powder according to Example 1.

### Comparative Example 2

An electrode sample is manufactured according to the same method as Example 4, except for using the conductive powder according to Comparative Example 1 instead of the conductive powder according to Example 1.

### Example 7

The conductive powder according to Example 1 and silver (Ag) particles are added to an organic vehicle including an ethyl cellulose binder, a surfactant, and a mixed solvent of butyl carbitol/butyl carbitol acetate. Herein, the conductive powder according to Example 1 and the silver (Ag) particles are included in a ratio of 80:20 (v/v). Subsequently, the mixture is kneaded with a 3-roll mill, preparing a conductive paste.

The conductive paste is coated on a silicon wafer in a screen printing method to form a pattern having a predetermined length. Subsequently, an electrode sample is formed by heating the patterned silicon water to about 600° C. in belt furnace and then cooling it. In other words, a process temperature setting of a furnace used to heat the patterned silicon wafer may be about 600° C.

### Example 8

An electrode sample is manufactured according to the same method as Example 7, except for using the conductive powder according to Example 2 instead of the conductive powder according to Example 1.

### Example 9

An electrode sample is manufactured according to the same method as Example 7, except for using the conductive powder according to Example 3 instead of the conductive powder according to Example 1.

### Comparative Example 3

An electrode sample is manufactured according to the same method as Example 7, except for using the conductive powder according to Comparative Example 1 instead of the conductive powder according to Example 1.

### Evaluation 3

### Conductivity

Line resistance of the electrode samples according to Examples 4 to 9 and Comparative Examples 2 and 3 is evaluated. The line resistance is measured by using a 2-point probe, and specifically, the probes are respectively joined with both ends of the electrode sample to measure resistance, and the resistance is divided by the length of the electrode.

The results are provided in Table 2.

TABLE 2

| | Line resistance (Ω/cm) |
|---|---|
| Example 4 | 0.11 |
| Example 5 | 0.11 |
| Example 6 | 0.12 |
| Comparative Example 2 | 0.14 |
| Example 7 | 0.19 |
| Example 8 | 0.20 |
| Example 9 | 0.21 |
| Comparative Example 3 | 0.26 |

Referring to Table 2, the electrode samples according to Examples 4 to 6 show improved line resistance compared with the electrode sample according to Comparative Example 2, and the electrode samples according to Examples 7 to 9 show improved line resistance compared with the electrode sample according to Comparative Example 3. Accordingly, a conductive powder according to example embodiments may improve a conductivity of an electrode.

It should be understood that example embodiments described herein should be considered in a descriptive sense only and not for purposes of limitation. Descriptions of features or aspects within each conductive powder, metallic glass, and/or conductive paste according to example embodiments or methods of forming the same should typically be considered as available for other similar features or aspects in other conductive powders, metallic glasses, and/or conductive pastes according to example embodiments or other methods of forming the same.

While some example embodiments have been particularly shown and described, it will be understood by one of ordinary skill in the art that variations in form and detail may be made therein without departing from the spirit and scope of the claims.

What is claimed is:

1. A conductive powder, comprising
a metallic glass, and
a coating on a surface of the metallic glass, the coating including a metal.

2. The conductive powder of claim 1, wherein an oxidation resistance of the metal in the coating is higher than an oxidation resistance of the metallic glass.

3. The conductive powder of claim 1, wherein the metal comprises one of silver (Ag), gold (Au), palladium (Pd), platinum (Pt), ruthenium (Ru), rhodium (Rh), osmium (Os), iridium (Ir), rhenium (Re), titanium (Ti), niobium (Nb), tantalum (Ta), aluminum (Al), copper (Cu), nickel (Ni), molybdenum (Mo), vanadium (V), zinc (Zn), magnesium (Mg), yttrium (Y), cobalt (Co), zirconium (Zr), iron (Fe), tungsten (W), tin (Sn), chromium (Cr), manganese (Mn), and a combination thereof.

4. The conductive powder of claim 1, wherein the metallic glass is an alloy including at least one of copper (Cu), titanium (Ti), nickel (Ni), zirconium (Zr), iron (Fe), magnesium (Mg), calcium (Ca), cobalt (Co), palladium (Pd), platinum (Pt), gold (Au), cerium (Ce), lanthanum (La), yttrium (Y), gadolinium (Gd), beryllium (Be), tantalum (Ta), gallium (Ga), aluminum (Al), hafnium (Hf), niobium (Nb), lead (Pb), platinum (Pt), silver (Ag), phosphorus (P), boron (B), silicon (Si), carbon (C), tin (Sn), zinc (Zn), molybdenum (Mo), tungsten (W), manganese (Mn), erbium (Er), chromium (Cr), praseodymium (Pr), thulium (Tm), and a combination thereof.

5. The conductive powder of claim 1, wherein
the metallic glass is in the form of particles, and
a thickness of the coating is less than or equal to about 20% of a particle diameter of the metallic glass.

6. The conductive powder of claim 1, wherein a thickness of the coating is about 1 nm to about 3 μm.

7. An article comprising:
a sintered product of the conductive powder of claim 1.

8. The article of claim 7, wherein the sintered product of the conductive powder comprises:
a crystallized product of the metallic glass, and
a sintered metal surrounding the crystallized product of the metallic glass.

9. A conductive paste, comprising
a conductive powder and an organic vehicle,
the conductive powder including a metallic glass and a coating on a surface of the metallic glass, and
the coating including a metal.

10. The conductive paste of claim 9, wherein an oxidation resistance of the metal is higher than an oxidation resistance of the metallic glass.

11. The conductive paste of claim 9, wherein the metal comprises one of silver (Ag), gold (Au), palladium (Pd), platinum (Pt), ruthenium (Ru), rhodium (Rh), osmium (Os), iridium (Ir), rhenium (Re), titanium (Ti), niobium (Nb), tantalum (Ta), aluminum (Al), copper (Cu), nickel (Ni), molybdenum (Mo), vanadium (V), zinc (Zn), magnesium (Mg), yttrium (Y), cobalt (Co), zirconium (Zr), iron (Fe), tungsten (W), tin (Sn), chromium (Cr), manganese (Mn), and a combination thereof.

12. The conductive paste of claim 9, wherein the metallic glass is an alloy including at least one of copper (Cu), titanium (Ti), nickel (Ni), zirconium (Zr), iron (Fe), magnesium (Mg), calcium (Ca), cobalt (Co), palladium (Pd), platinum (Pt), gold (Au), cerium (Ce), lanthanum (La), yttrium (Y), gadolinium (Gd), beryllium (Be), tantalum (Ta), gallium (Ga), aluminum (Al), hafnium (Hf), niobium (Nb), lead (Pb), platinum (Pt), silver (Ag), phosphorus (P), boron (B), silicon (Si), carbon (C), tin (Sn), zinc (Zn), molybdenum (Mo), tungsten (W), manganese (Mn), erbium (Er), chromium (Cr), praseodymium (Pr), thulium (Tm), and a combination thereof.

13. The conductive paste of claim 9, wherein
the metallic glass is in the form of particles, and
a thickness of the coating is less than or equal to about 20% of a particle diameter of the metallic glass.

14. The conductive paste of claim 9, wherein a thickness of the coating is about 1 nm to about 3 μm.

15. The conductive paste of claim 9, further comprising:
metal particles.

16. The conductive paste of claim 15, wherein the metal particles comprise one of silver (Ag), aluminum (Al), copper (Cu), nickel (Ni), and a combination thereof.

17. An electronic device comprising:
a sintered product of the conductive paste according to claim 9.

18. The electronic device of claim 17, wherein the sintered product of the conductive paste comprises:
a crystallized product of the metallic glass, and
a sintered metal surrounding the crystallized product of the metallic glass.
